(19) United States
(12) Patent Application Publication
(10) Pub. No.: US 2012/0062714 A1
(43) Pub. Date: Mar. 15, 2012

(54) REAL-TIME SCOPE TRACKING AND BRANCH LABELING WITHOUT ELECTRO-MAGNETIC TRACKING AND PRE-OPERATIVE SCAN ROADMAPS

(75) Inventors: Xin Liu, Yonkers, NY (US); Luis Felipe Gutierrez, Jersey City, NJ (US)

(73) Assignee: KONINKLIJKE PHILIPS ELECTRONICS N.V., EINDHOVEN (NL)

(21) Appl. No.: 13/319,116

(22) PCT Filed: Apr. 2, 2010
(86) PCT No.: PCT/IB2010/051452

§ 371 Date: Nov. 7, 2011

Related U.S. Application Data
(60) Provisional application No. 61/176,539, filed on May 8, 2009.

(51) Int. Cl. H04N 7/18; G06K 9/00

(52) U.S. Cl. 348/65; 382/107; 348/E07.085

(57) ABSTRACT

A system and method for locating a position of an imaging device include a guided imaging device (102) configured to return images of internal passageways to a display (124). A processing module (114) is configured to recognize patterns from the images and employ image changes to determine motion undergone by the imaging device such that a position of the imaging device is determined solely from information received from images obtained internally in the passageways and general knowledge of the passageways.

This disclosure relates to imaging tools, and more particularly to a system and method for mapping internal passages to maintain spatial orientation and direction during navigation.

Endoscopy is a minimally invasive real-time imaging modality in which a camera is inserted into the body for visual inspection of internal structures such as the lung airways or the gastrointestinal system. Typically, the endoscope is a long flexible fiber-optic system connected to a light source at a proximal end outside of a patient's body and a lens at a distal end inside the patient's body. In addition, some endoscopes include a working channel through which the operator can perform suction or pass instruments such as brushes, biopsy needles or forceps. Video feedback gives a physician or technician cues to maneuver the scope to a targeted region.

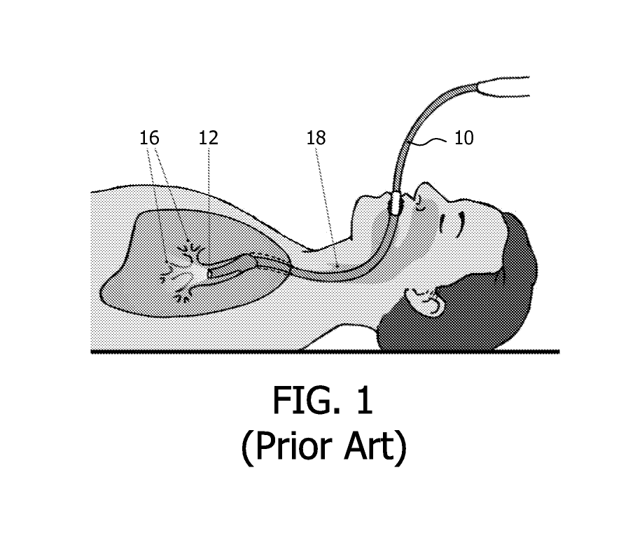

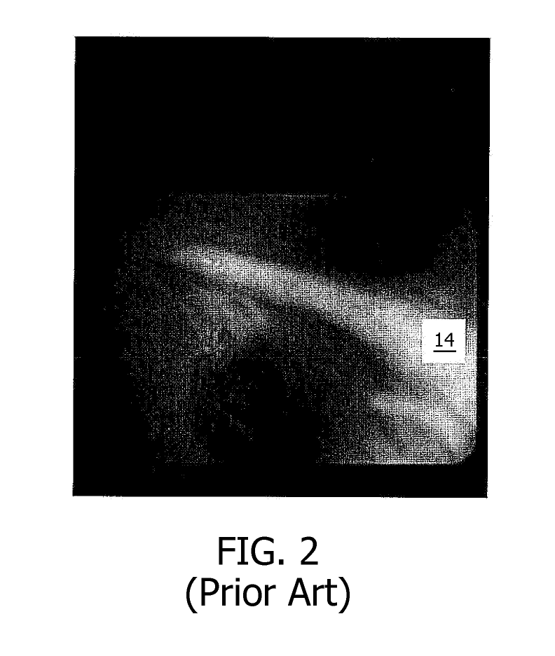

Referring to FIG. 1, an illustrative sketch of a typical bronchoscopy setup is illustratively shown. A bronchoscope 10 is inserted through patient's mouth and windpipe 18 and into lung airways 16. A light 12 is employed to illuminate the airways and to capture video images from the bronchoscope. A video image 14 (FIG. 2) is output and displayed for viewing the airways.

Image guided endoscopy, as compared to conventional endoscopy, enjoys the advantage of its real-time connection to a three-dimensional (3D) roadmap of the lung by fusing pre-operative computed tomography (CT) images with video data. While the interventional procedure is performed, physicians can determine where the scope is located with respect to the 3D CT space. In the research of bronchoscope localization, there are three types of ways to track the tip of the endoscope. Type (a) tracks based on a position sensor mounted to the tip of the endoscope; Type (b) tracks based on live image registration, and Type (c) is a combination of types (a) and (b) two.

Electro-magnetic (EM) guided endoscopy (type (a) system) has been recognized as a valuable tool for many lung applications, but it requires employing a supplemental guidance device. Image-registration based endoscopy (type (b) system), requires constant real-time frame-by-frame registration which can be time consuming, and prone to errors when fluids inside the airway obscure the video images. All of these systems, however, despite utilizing EM tracking or image-registration based tracking, demand a fast and powerful computer workstation (equipped with fine-resolution CT data) that is enabled to execute a multitude of non-trivial tasks, such as bronchus segmentation, image registration, path planning and real-time navigation. This technological integration, particularly with the fine resolution pre-operative CT images, poses an enormous challenge to many remote, less resourceful regions (particularly in developing countries) where hospitals have limited access to advanced technology while lung cancer occurrence in these regions may be extraordinarily high.

In accordance with the present principles, given that an obstacle in most bronchoscopy procedures resides in that the physicians lose spatial orientation in highly convoluted airways, a novel solution incorporates a video-based navigation method to a bronchoscopy suite. Instead of tracking the entire course of scope trajectory, directions are provided when the scope reaches branching intersections by analyzing video sequences. In this way, cues can be provided in the video images as to which way to go to reach a target or to indicate the current position of the tip of the scope. By analyzing motion fields of the video sequences, the system is able to label the branches of the airways or other branched cavities. The present solution is very cost-effective and does not need pre-operative CT images to be reconstructed as the roadmap, nor additional position tracking facilities (such as electro-magnetic (EM) tracking). Thus, this versatile solution can be applied to almost all pulmonology clinics, especially where access to advanced technology is limited. This guidance technology is particularly useful to pulmonology physicians, and more particularly to physicians in less-developed areas or countries. The present embodiments reduce or eliminate the need to purchase additional guidance devices or computer workstations to perform the navigation tasks.

A system and method for locating a position of an imaging device includes a guided imaging device configured to return images of internal passageways to a display. A processing module is configured to recognize patterns from the images and employ image changes to determine motion undergone by the imaging device such that a position of the imaging device is determined solely from information received from images obtained internally in the passageways and general knowledge of the passageways.

Another system for locating a distal end of an endoscope includes an illuminated endoscope tip mounted on a cable and configured to receive reflected light signals. A display is configured to render images received from the tip. A processing module is configured to recognize patterns from the images and employ image changes to determine direction choices and motion undergone by the tip. A general anatomical reference cross-references recognized patterns and image changes to the anatomical reference, wherein the position of the tip is determined relative to features deciphered from recognized patterns and image changes and the anatomical reference.

A method for locating a distal end of an endoscope includes illuminating an area around an endoscope tip, receiving reflected light through the tip, rendering images received from the tip, recognizing patterns from the images and employing image changes to determine motion undergone by the tip, and cross-referencing recognized patterns and image changes against a general anatomical reference, wherein the position of the tip is determined relative to features deciphered from the images and the anatomical reference.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

FIG. 1 is a cross-sectional view of a human patient undergoing a bronchoscopy procedure in accordance with the prior art;

FIG. 2 is an image of a bronchial bifurcation of a human patient in accordance with the prior art;

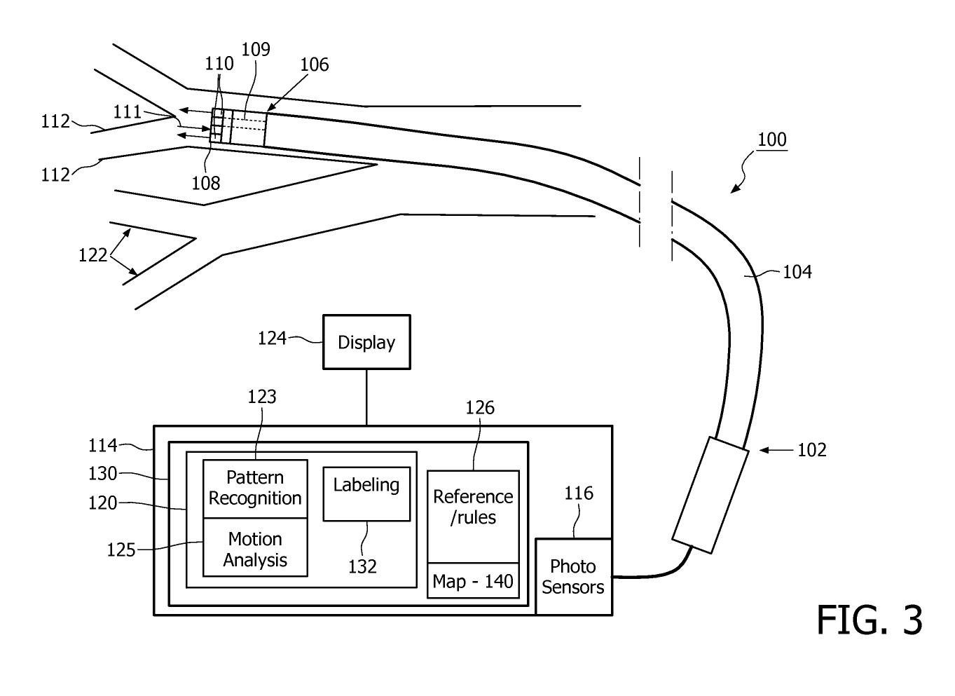

FIG. 3 is a block diagram showing a system with an internal view of a branching passageway system in accordance with one embodiment;

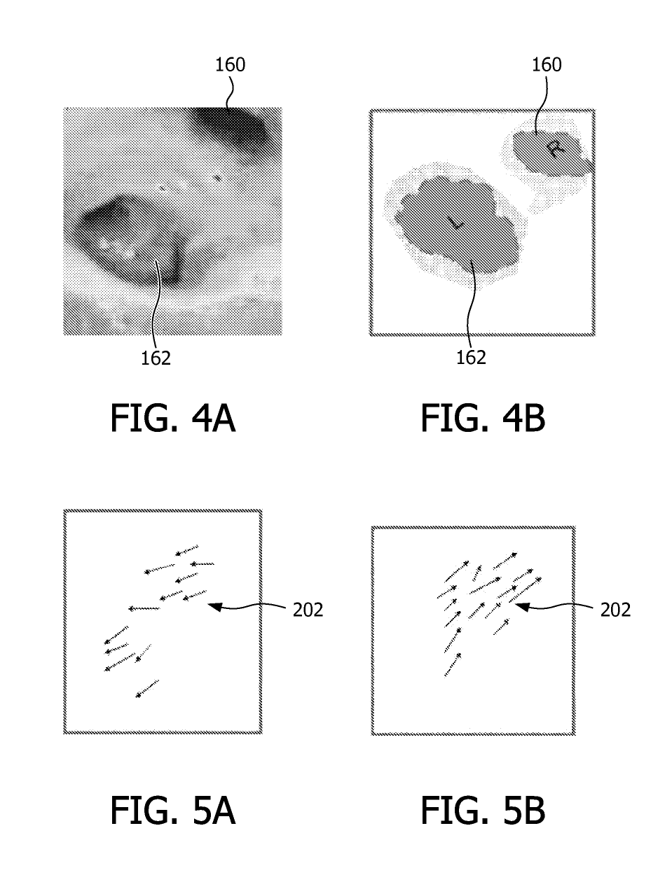

FIG. 4A is an image of a bronchial bifurcation subjected to pattern recognition to identify the bifurcation in accordance with one embodiment;

FIG. 4B is an diagram showing a processed view of the image of FIG. 4A with labels indicated in accordance with one embodiment;

FIGS. 5A and 5B are diagrams showing vector fields for determining translation of an image gathering device as determined from images of a scope in accordance with one embodiment;

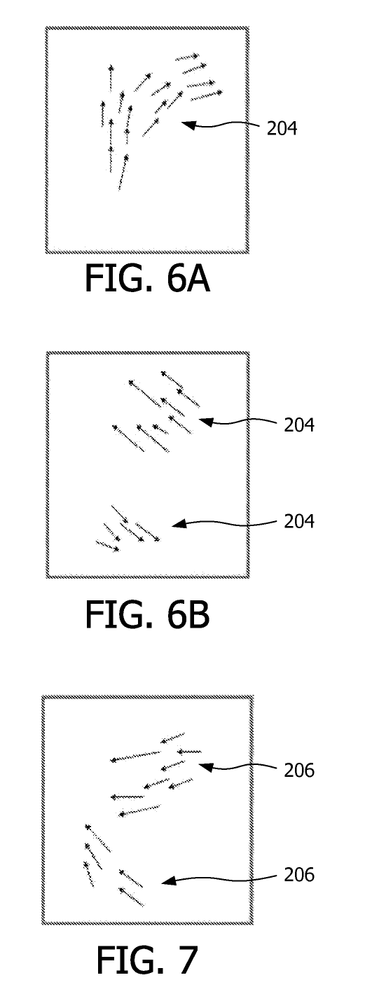

FIGS. 6A and 6B are diagrams showing vector fields for determining rotation of an image gathering device as determined from images of a scope in accordance with one embodiment;

FIG. 7 is a diagram showing vector fields for determining forward or backward motion of an image gathering device as determined from images of a scope in accordance with one embodiment; and

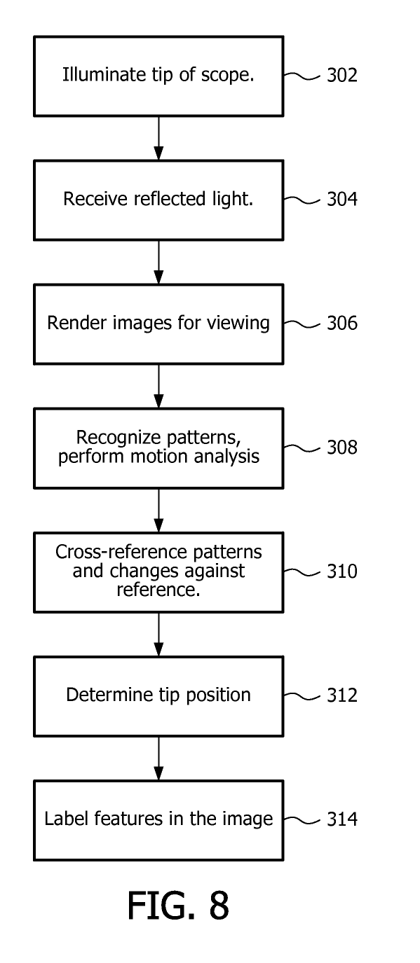

FIG. 8 is a flow diagram showing steps for locating an endoscope end portion in accordance with an illustrative embodiment.

The present disclosure describes an apparatus and method for scope navigation and imaging. The present principles analyze motion fields of scope video sequences to identify and label branches. In particularly useful embodiments, the scope may include a bronchoscope or any scope for pulmonary, digestive system, or other minimally invasive surgical viewing. In other embodiments, an endoscope or the like is employed for other medical procedures as well. These procedures may include minimally invasive endoscopic pituitary surgery, endoscopic skull base tumor surgery, intraventricular neurosurgery, arthroscopic surgery, laparoscopic surgery, etc. In other embodiments, the scope may be configured for viewing internal plumbing, pipe systems or for scoping animal or insect burrows. Other scoping applications are also contemplated. The present principles include components which (1) recognize patterns to identify bifurcations (or trifurcations, etc.) in video images, (2) use video motion detection to detect motion of the scope and the direction(s) of each turn, (3) using a rule-based technique to trigger a pre-defined knowledge base that can be derived from the anatomical imaging data and (4) using the 3D topology of known anatomy of the examined structures to determine where the scope is located in three dimensions after the scope makes a sequence of turns. Branches may be labeled dynamically on the display screen of the scope. The present embodiments are cost-effective for a plurality of reasons, e.g., pre-operative CT images are not needed to be reconstructed as a roadmap and position tracking facilities (such as EM tracking) are not needed.

Radial motion field vectors are employed to designate camera movement decisions (e.g., the viewing camera moves away from the scene—the vectors converge, and the viewing camera moves toward the scene—the vectors diverge). The motion fields (2D vector fields of velocities of the image feature points) are preferably employed to show the viewing camera is making different movements. When a turning translation (parallel translation) motion is discovered, a corresponding branch can be labeled accordingly on a display. The methods described herein can be built into a video-processor of an endoscope without the need for a powerful computer workstation (to perform air-way extraction, volume rendering and registration, etc.). This tracking technology would then be available where the cost of the workstation cannot be justified (e.g., at a rural pulmonology clinic). The methods described herein may also be implemented on a computer or in a custom designed apparatus.

It should be understood that the present invention will be described in terms of a bronchoscope; however, the teachings of the present invention are much broader and are applicable to any optical scope that can be employed in internal viewing of branching, curved, coiled or other shaped systems (e.g., digestive systems, circulatory systems, piping systems, animal or insect passages, mines, caverns, etc.). Embodiments described herein are preferably displayed for viewing on a display monitor. Such monitors may include any suitable display device including but not limited to handheld displays (e.g., on personal digital assistants, telephone devices, etc.), computer displays, televisions, designated monitors, etc. Depending of the scope, the display may be provided as part of the system or may be a separate unit or device.

It should also be understood that the optical scopes may include a plurality of different devices connected to or associated with the scope. Such devices may include a light, a cutting device, a brush, a vacuum, a camera, etc. These components may be formed integrally with a head on a distal end portion of the scope. The optical scopes may include a camera disposed at a tip of the scope or a camera may be disposed at the end of an optical cable opposite the tip. Embodiments may include hardware elements, software elements or both hardware and software elements. In a preferred embodiment, the present invention is implemented with software, which includes but is not limited to firmware, resident software, microcode, etc.

Furthermore, the present principles can take the form of a computer program product accessible from a computer-usable or computer-readable medium providing program code for use by or in connection with a computer or any instruction execution system. A computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The processor or processing system may be provided with the scope system or provided independently of the scope system. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Referring now to the drawings in which like numerals represent the same or similar elements and initially to FIG. 3, an optical scope system 100 is illustratively shown. System 100 includes an illuminated scope 102, such as a fiber optic scope, or a scope with a camera 108 employed in viewing internal cavities and in particular airway passages in a living organism. Scope 102 includes a flexible cable 104 that may include an optical fiber therein and preferably includes a working channel 109 along its length for aspiration or insertion of tools. A tip 106 on a distal end portion of the cable 104 includes camera 108 and at least one light source 110. A light may be affixed on the end portion of the scope or light may be transmitted from a distal end of the cable 104 through a fiber optic link, depending on the system. Tip 106 may also include other tools or attachments depending on the application and procedure. Two types of endoscopes may be employed: a fiber optic scope or a video scope. The fiber optic scope may include a charge coupled device (CCD) camera at the distal end of the cable 104, while the video scope may include a CCD camera set close to or on the tip 106.

Light reflected 111 from walls of internal tissues 112 is detected and propagated down the cable 104 as optical (or electrical) signals. The signals are interpreted preferably using a processing device 114, such as a computer or other platform configured with a photosensing device 116 in the case of a distally disposed camera. Photosensing device 116 may be mounted on a printed circuit board, be included in a camera device (e.g., a CCD camera) or be integrated in an integrated circuit chip. Many configurations and implementations may be employed to decipher and interpret the optical signals. If the camera is included in the tip 106, the signals are converted to electrical signals and interpreted by the processing device without photosensing device 116.

Processing device 114 may include a computer device, processor or controller configured to implement a program or programs 120. The program 120 includes instructions for interpreting and executing functions in accordance with the present principles. The program 120 may dynamically label branches, such as bronchial branches 122, where the scope tip 106 is currently located. The labeling process is an inexpensive alternative to perform navigation guidance for procedures such as a bronchoscopy procedure.

The processing device 114 provides dynamic labeling of airway branches 122 into an existing screen or display 124 of scope 102. No additional external monitor or work station is needed. By analyzing the video streams' motion patterns, the processing device 114 determines where the tip 106 of scope 102 is located, e.g., in the left primary bronchus or the right tertiary bronchus. No external tracking instruments are needed. The registration to high resolution pre-op CT images can also be omitted.

Features of the program 120 include a pattern recognition program 123 to identify bifurcations in video images. A motion detection program 125 is also used to detect if the scope is making a turn, and if so, which direction the scope takes. A general reference (e.g., an anatomical reference) 126 is also stored in memory 130. The general anatomical reference 126 stores prior knowledge about airway anatomy (as generic information, as opposed to CT scans or other imaging scans). This airway anatomy can be presented in the form of a set of rules or a 3D topology map. According to different designs, a rule-based technique or a model-based geographic matching algorithm can be used to determine where the scope is located after the scope makes a sequence of turns. It should be noted that a prior understanding on the particular patient is not needed and the rule or model may be used for all patients, hence generic information.

The rule-based technique uses features identified through pattern recognition to provide a connected path of previously traversed portions of the passageway. In other words, the present principles employ milestones or identify features in the passageway to help determine where the scope is located. For example, each bifurcation is pattern recognized followed by a determination of which bifurcation was selected to go down. This information will determine the current location. This process continues so that the location of the endoscope is known throughout the process. Rules such as a sequence of directions (e.g., left, right, left) may be employed to identify a present position of the tip 106.

Another approach may employ topology mapping and comparison to an atlas of lung airway anatomy. Based on the real-time motion analysis, it is possible to establish the topology (the qualitative shape) of the airways traversed by the endoscope using the camera's internal parameters. Until the tertiary bronchi, the topology is largely conserved across subjects, such that a standard topology can be described, with each segment of the topology named according to the typical conventions of pulmonologists. Based on the standard topology from the atlas and the observed topology of the airways traversed by the endoscope, the current location of the endoscope can be described relative to the atlas, and then the atlas naming convention is used to identify the current airway segment.

The scope 102 may include its own video-processor or the video-processor may be part of the processing device 114. The components built into the video-processor of the endoscope employ the signals to detect patterns in the images and then use the patterns to identify a position in the system or body. The endoscope monitor 124 will display not only the current video feedback, but also, preferably, the labeling information of each branch where the scope is located. Pattern recognition 123 identifies the bifurcation of the passage. Due to the nature of illumination in the endoscope system 100, the further (deeper) objects are located, the less they are illuminated. Thus, in the lungs, two bronchial sub-branches present less illuminated images in the video than the main branch from which they originated.

Due to the nature of design, after multiple trips within the airway tunnels, the present approach may disorientate the endoscope if initialization parameters are not correctly chosen. Thus, we propose using, e.g.: a) a local initialization method to start tracking when the bifurcations are seen in the video image, and/or b) a global initialization method where the length of endoscope that is inside the human body is taken into consideration. In the latter case, this depth information is recorded as a geographic parameter to constrain the possible location (or location range) of the tip of the endoscope. Thus, by knowing if the scope has reached the peripheral region or is still in the central airway, one can obtain better initialization parameters.

In FIG. 4A, an image shows two blubs 160 and 162 representing a bifurcated passageway in the lungs of a patient. When two big dark blubs 160 and 162 fill a considerable portion of the field of view of the camera, for example, the scope should be considered as arriving at an intersection point. This pattern is easily recognized in a pattern recognition program 123. As a blub gets larger, the motion analysis program 125 interprets this as a selection of that blub (left or right, top or bottom). Using an anatomical map of reference 126 also programmed into memory 130 of the processing device 114, the present location of the tip 106 can be tracked through the passageways of the lungs. FIG. 4B shows a post-processed image of the image of FIG. 4A with labels “L” (left) and “R” (right) over the passages.

A real time motion analysis method 125 is stored in memory 130 and is employed to analyze images to determine a position or change in position. The method 125 can compare a current image map to a previous image map to determine direction, velocity, rotation, translation and other parameters. The motion analysis method 125 can use features in the image to track these parameters. Two sub-problems of motion analysis include 1) correspondence of elements: that is which elements of a frame correspond to which elements of a next frame of the sequence; and 2) reconstruction of motion: that is given a number of corresponding elements, what can be understood about the 3-D motion of the observed world.

In one embodiment, a Scale Invariant Feature Transform (SIFT) is employed to identify image features for scene recognition and tracking. Using SIFT, image features are invariant to image scaling and rotation, and partially invariant to change in illumination and 3D camera viewpoint. Other motion detection methods may also be employed such as optical flow methods, etc.

Based on 2D motion fields of sparse image features computed over time, a motion of the camera can be determined by tracking changes to the image based on one or more reference points (e.g., a predefined point with known absolute coordinates in 3D space). According to one or more reference points which show absolute location and orientation in 3D space, a program will be able to determine if the scope is making a left turn or right turn, up or down and thus label the branch-to-be-entered correspondingly.

In FIGS. 5A and 5B, parallel motion field vectors 202 are illustratively depicted. In these images, the vector fields 202 indicate that the viewing camera provides translation motion (moves in the internal space). These vectors are generated by finding a feature in one image and finding that feature in a subsequent image to determine the changes. Video analysis tools may be adapted to provide this functionality. In FIGS. 6A and 6B, rotation motion field vectors 204 indicate that a viewing camera rotates around the optical axis. Radial motion field vectors indicate that the viewing camera moves away from the scene when the vectors converge and moves toward the scene when the vectors diverge. FIG. 7 shows converging vectors 206.

Referring again to FIG. 3, in one embodiment, a labeling feature 132 is employed when the motion field (2D vector field of velocities of the image feature points) shows the viewing camera is making different movements. For example, when the turning translation (parallel translation) motion is determined, a corresponding branch or branches will be labeled or indicated accordingly. The labeling will appear on the display 124 to be viewed by the operator. Labeling may include any symbol, feature or word. Motion analysis module 125 is programmed to differentiate the motion difference between translation motion (turning translation and small shifting translation), rotation motion (along the optical axis of the camera) and progression (inward versus outward) translation motion, etc. To robustly categorize and classify the motions fields, one could use machine learning techniques to discover more consistent features encountered in the video sequence of each application domain.

In the illustrative embodiment, the scope preferably uses the knowledge of lung anatomy to name the branch where the scope is currently located. This may include a coordinate map 140 of anatomical data 126. The data in the map 140 may include ranges of dimensions for internal organs or features, include adjustments for individuals based on e.g., age, gender, surgical history, ethnicity, etc. The map 140 provides a reference against which images may be compared or features deciphered to be capable of identifying milestones, targets, abnormalities, etc. Since no pre-op CT roadmap is used for guidance, a set of rules, or an atlas based approach may be employed to determine the spatial location of the scope based on the sequence of turns it makes and gross anatomy of lung airways. For example, a rule specifies that after the scope makes a left turn followed by another right turn, it is now located in a left secondary bronchus.

In one embodiment, depending on the circumstances, a patient's internal configuration may be mapped out in a preliminary procedure by inserting the scope of the present system into the patient and recording and cataloging the images as the scope moves through the patient. In this way, a record of the condition and features can be collected and stored. This method provides the most accurate location detection since the actual images are employed in the mapping and labeling. This is particularly useful when a particular patient undergoes or will undergo multiple procedures. For example, if a technician finds a lesion in a lung during a first procedure, stored data may be employed to assist in guiding the technician back to that location. In this way, instead of labeling a current position, the technician is provided with internal directions on how to achieve a particular position. It should be understood that video images of entire procedures may be stored to provide a motion video of the procedure.

The present principles can be applied in pulmonology procedures, digestive procedures, or any other procedure where an endoscope or other camera device needs to be tracked. The present principles are particularly useful where access to advanced technology (such as powerful computers, position tracking devices, external monitors) is limited. The system is very cost-effective and does not require high-resolution pre-operative CT images to be reconstructed as the roadmap.

Referring to FIG. 8, a method for locating a distal end of an endoscope is illustratively shown. In block 302, an endoscope tip is illuminated. In block 304, reflected light is received through the tip of the endoscope. Images received from the optical cable are rendered for viewing by a medical technician or physician in block 306. In block 308, patterns are recognized from the images and image changes are employed to determine motion undergone by the tip. Recognizing patterns includes interpreting images to identify features in the passageways. The image changes are used to perform motion analysis to interpret movement in the images to create a log of previously traversed passageways. The motion analysis includes generating motion vector fields to determine translation, rotation and passage choice during imaging.

In block 310, recognized patterns and image changes are cross-referenced against a general anatomical reference. The position of the tip is determined relative to features deciphered from the images and the anatomical reference in block 312. In block 314, features in the images on a display are labeled to identify a position of the endoscope tip. This is preferably performed in real-time to give clues as to which passage to select or to maintain spatial orientation of the technician/user during the procedure.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for systems and methods for real-time scope tracking and branch labeling without electro-magnetic tracking and pre-operative scan roadmaps (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims.

Having thus described the details and particularity required by the patent laws, what is claimed and desired protected by Letters Patent is set forth in the appended claims:

1. A system for locating a position of an imaging device, comprising:
a guided imaging device (102) configured to return images of internal passageways to a display (124); and
a processing module (114) configured to recognize patterns from the images and employ image changes to determine direction choice and motion undergone by the imaging device such that a position of the imaging device is determined solely from recognized patterns and image changes received from images obtained internally in the passageways and general knowledge of the passageways.

2. The system as recited in claim 1, wherein the processing module (114) has associated memory (130) which stores a pattern recognition program (123), the pattern recognition program is executable by the processing module to interpret images to identify features in the passageways.

3. The system as recited in claim 1, wherein the processing module (114) has associated memory (130) which stores a motion analysis program (125), the motion analysis program is executable by the processing module to interpret movement in the images to create a log of previously traversed passageways.

4. The system as recited in claim 3, wherein the motion analysis program (125) generates motion vector fields (202, 204, 206) to determine translation, rotation and passage choice during imaging.

5. The system as recited in claim 1, wherein the processing module (114) includes a labeling device (132) configured to generate a label to be displayed on a display screen identifying a pattern of features determined to be in the image.

6. The system as recited in claim 5, wherein the label identifies a position of the guided imaging device (102).

7. The system as recited in claim 1, wherein the guided imaging device (102) includes an endoscope.

8. A system for locating a distal end of an endoscope, comprising:
an illuminated endoscope tip (106) mounted on a cable (104) and configured to receive reflected light signals (111);
a display (124) configured to render images received from the tip;
a processing module (114) configured to recognize patterns from the images and employ image changes to determine direction choices and motion undergone by the tip; and
a general anatomical reference (126, 140) to cross-reference recognized patterns and image changes against the anatomical reference, wherein the position of the tip is determined relative to features deciphered from recognized patterns and image changes and the anatomical reference.

9. The system as recited in claim 8, wherein the processing module (114) has associated memory (130) which stores a pattern recognition program (123), the pattern recognition program is executable by the processing module to interpret images to identify features in passageways.

10. The system as recited in claim 8, wherein the processing module (114) has associated memory (130) which stores a motion analysis program (125), the motion analysis program is executable by the processing module to interpret movement in the images to create a log of previously traversed passageways.

11. The system as recited in claim 10, wherein the motion analysis program generates motion vector fields (202, 204, 206) to determine translation, rotation and passage choice during imaging.

12. The system as recited in claim 8, wherein the processing module (114) includes a labeling device (132) configured to generate a label to be displayed on a display screen identifying a pattern of features determined to be in the image.

13. The system as recited in claim 12, wherein the label identifies a position of the endoscope tip.

14. The system as recited in claim 8, wherein the endoscope includes a bronchoscope.

15. A method for locating a distal end of an endoscope, comprising:
illuminating (302) an area around an endoscope tip;
receiving (304) reflected light through the tip;
rendering (306) images received from the tip;
recognizing (308) patterns from the images and employing image changes to determine motion undergone by the tip; and
cross-referencing (310) recognized patterns and image changes against a general anatomical reference, wherein the position of the tip is determined (312) relative to features deciphered from the images and the anatomical reference.

16. The method as recited in claim 15, wherein recognizing (308) patterns includes interpreting images to identify features in passageways.

17. The method as recited in claim 15, wherein employing image changes includes performing motion analysis to interpret movement in the images to create a log of previously traversed passageways.

18. The method as recited in claim 17, wherein performing motion analysis includes generating motion vector fields to determine translation, rotation and passage choice during imaging.

19. The method as recited in claim 15, further comprising labeling (314) features in the images on a display to identify a position of the endoscope tip.

20. The method as recited in claim 15, wherein the endoscope includes a bronchoscope.
